(19) United States
(12) Patent Application Publication
(10) Pub. No.: US 2009/0046461 A1
(43) Pub. Date: Feb. 19, 2009

(54) LED Light String

(76) Inventor: Ben Fan, He Shan City (CN)

Correspondence Address: Kamrath & Associates, P.A., Suite 245, 4825 Olson Memorial Highway, Golden Valley, MN, 55422, US

(21) Appl. No.: 11/838,945

(22) Filed: Aug. 15, 2007

(51) Int. Cl. F21V 3/02; F21V 13/00

(52) U.S. Cl. 362/242; 362/235

(57) ABSTRACT

An LED light string has multiple wires, multiple un-encapsulated LEDs, multiple transparent casings, multiple primary spheres and multiple auxiliary spheres. The un-encapsulated LEDs are mounted on the wires. The transparent casings respectively receive the un-encapsulated LEDs and have multiple heat-dissipation holes to dissipate heat from the un-encapsulated LEDs. The primary spheres are transparent, respectively receive the transparent casings and have multiple trapezoid indentations defined in outer surfaces of the primary spheres. The auxiliary spheres are mounted around the wires and also have multiple trapezoid indentations. The trapezoid indentations of the primary and the auxiliary spheres scatter the light from the un-encapsulated LEDs to generate a dazzling visual effect.

### BACKGROUND OF THE INVENTION

1. Field of the Invention

The present invention relates to a light string, and more particularly to a light emitting diode (LED) light string that is capable of emitting scattering light to enhance the illumination and decorative purpose.

2. Description of the Prior Art

Current light emitting diode (LED) light string is composed of multiple LEDs connected in series via multiple secondary electrical wires and then the connected LEDs are connected to a primary electrical wire. Most of the available LED light strings adopt encapsulation process to encapsulate the LEDs within a transparent material, such as resin. After the encapsulation process, the light coming from the LEDs is soft and has an effect almost the same as that of a neon light.

Giving up the conventional light bulbs and adopting the LEDs as the illuminator is that the LED is inexpensive and has longer life span. Above all, the LED generates less heat than that of the conventional light bulb.

However, no matter how little the heat is generated by the LED, the heat resulted from the operation of the LED is enclosed by the encapsulation. Thus the heat dissipation efficiency of such a light string is poor and can not meet the market requirements.

To overcome the shortcomings, the present invention tends to provide an LED light string to mitigate the aforementioned problems.

### SUMMARY OF THE INVENTION

The primary objective of the present invention is to provide an light emitting diode (LED) light string that is capable of emitting scattering light and has great heat dissipation efficiency.

An LED light string has multiple wires, multiple un-encapsulated LEDs, multiple transparent casings, multiple primary spheres and multiple auxiliary spheres. The un-encapsulated LEDs are mounted on the wires. The transparent casings respectively receive the un-encapsulated LEDs and have multiple heat-dissipation holes to dissipate heat from the un-encapsulated LEDs. The primary spheres are transparent, respectively receive the transparent casings and have multiple trapezoid indentations defined in outer surfaces of the primary spheres. The auxiliary spheres are mounted around the wires and also have multiple trapezoid indentations.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of an LED light string in accordance with the present invention;

FIG. 2 is an exploded perspective view of the transparent casing of the LED light string in FIG. 1;

FIG. 3 is a perspective view showing the combination of the transparent casing and the auxiliary sphere of the LED light string in FIG. 1; and

FIG. 4 is a perspective view of the primary sphere.

### DETAILED DESCRIPTION OF THE PREFERRED EMBODIMENT

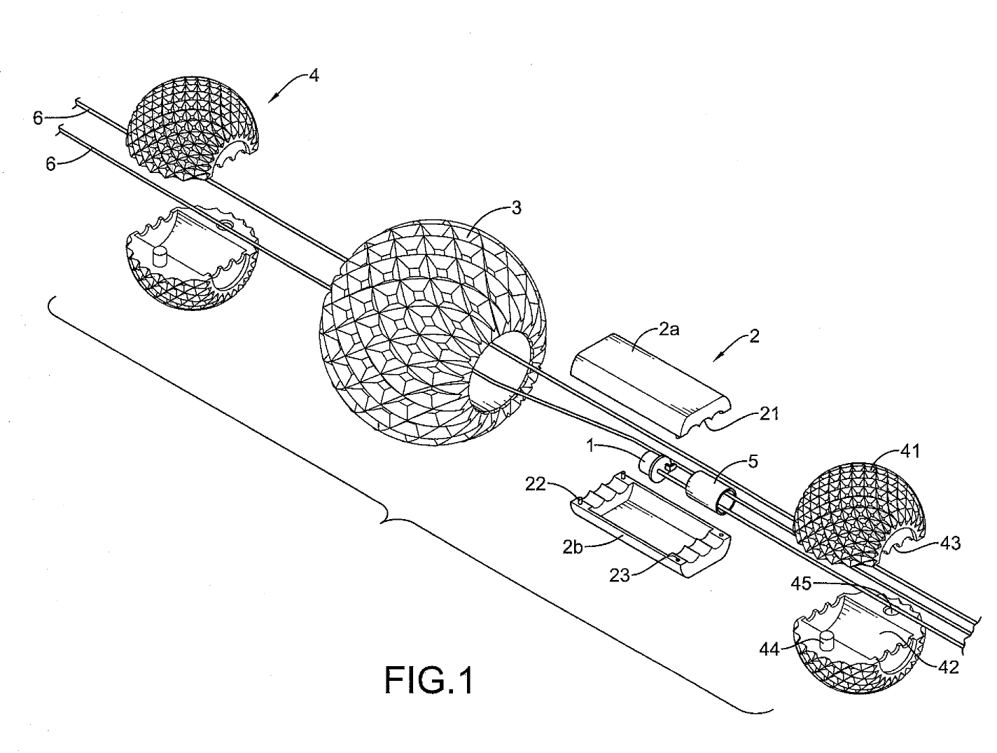

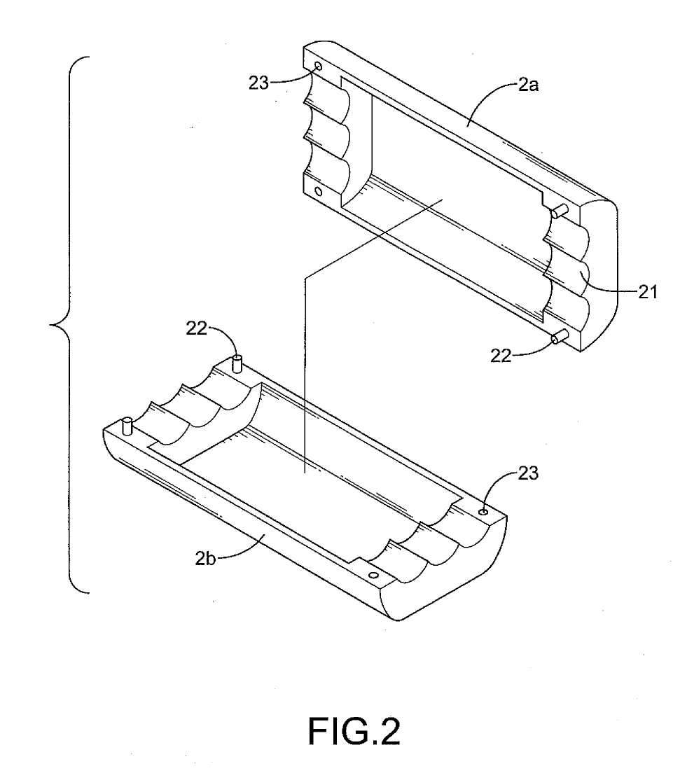

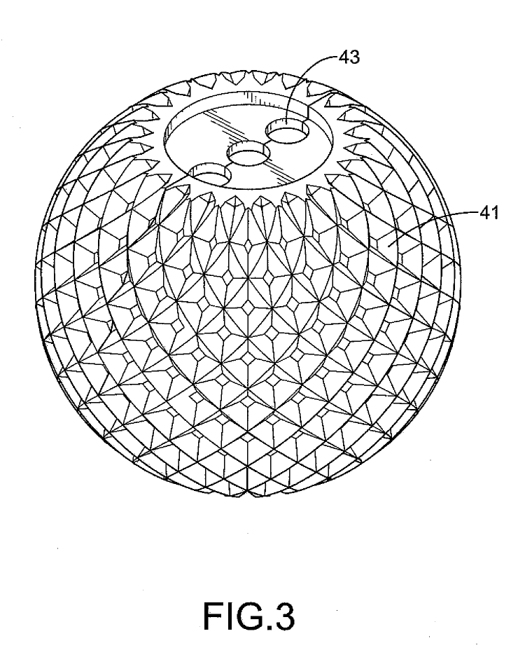

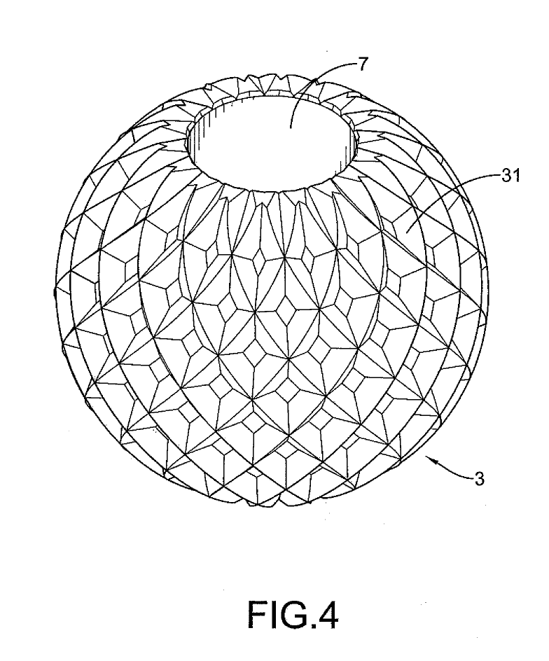

With reference to FIGS. 1-4, a light emitting diode (LED) light string in accordance with the present invention comprises multiple wires (6), multiple un-encapsulated LEDs (1), multiple heat-shrinkable tubes (5), multiple transparent casings (2), multiple primary spheres (3) and multiple auxiliary spheres (4).

The wires (6) are mounted on a circuit and may be electrified.

Each un-encapsulated LED (1) is implemented with a naked LED chip without a lens encapsulating the LED chip, is connected electrically to two of the wires (6) and may be electrified to light through the wires (6).

Each heat-shrinkable tube (5) is mounted tightly around two of the wires adjacent to one of the un-encapsulated LEDs (1).

The transparent casings (2) are mounted respectively around, respectively receive and hold the un-encapsulated LEDs (1). Each transparent casing (2) comprises two casing halves (2a, 2b) and has two ends, a cavity and two sets of multiple heat dissipation holes (21).

Each casing half (2a, 2b) has two ends, an inside edge, at least one mounting hole (23) and at least one mounting pin (22). The at least one mounting hole (23) is defined in the inside edge at the one end of the casing half (2a, 2b). The at least one mounting pin (22) is formed on the inside edge at the other end of the casing half (2a, 2b) and is mounted respectively in the at least one mounting hole (23) in the other casing half (2a, 2b) to assemble the transparent casing (2).

The cavity is defined in the transparent casing (2) and receives and holds one of the un-encapsulated LEDs (1).

The heat dissipation holes (21) of each set are defined in one end of the transparent casing (2), communicate with the cavity in the transparent casing (2) so that heat generated from the un-encapsulated LED (1) dissipates through the heat dissipation holes (21). Furthermore, at least two of the heat dissipation holes (21) of the each set allow at least two of the wires (6) to extend respectively through the at least two of the heat dissipation holes (21) of the set.

The primary spheres (3) are transparent, are mounted around, respectively receive and hold the un-encapsulated LEDs (1). Each primary sphere (3) has a center, an outer surface, a cavity, two end openings (7) and multiple trapezoid indentations (31).

The cavity is defined in the primary sphere (3) and receives and holds one of the transparent casings (2).

The end openings (7) are defined through the primary sphere (3), communicate with the cavity in the primary sphere (3) and allow the wires (6) to extend through the end openings (7).

The trapezoid indentations (31) may be reverse-flat-topped-pyramid shaped, are defined in the outer surface of the primary sphere (3) and are tapered inward toward the center. Light from the un-encapsulated LED (1) passing through the trapezoid indentations (31) is scattered by the trapezoid indentations (31) and generates a dazzling visual effect.

The auxiliary spheres (4) are transparent and are mounted around at least two of the wires (6), are arranged alternately with the primary spheres (3). Each primary sphere (3) comprises two semispherical halves and has a center, an outer surface, a cavity (42), two sets of multiple end openings (43) and multiple trapezoid indentations (41).

Each semispherical half has two opposite inside surfaces, a mounting hole (45) and a mounting pin (44). The mounting hole (45) is defined in one inside surface. The mounting pin (44) is formed on the other inside surface and is mounted in the mounting hole (45) in the other semispherical half to assemble the auxiliary sphere (4).

The cavity (42) is defined in the auxiliary sphere (4).

The end openings (43) of each set are defined through the auxiliary sphere (4) and communicate with the cavity (42) in the auxiliary sphere (4). Furthermore, at least two of the end openings (43) of each set allow at least two of the wires (6) to extend through the at least two of the end openings (43) of the set.

The trapezoid indentations (41) may be reverse-flat-topped-pyramid shaped, are defined in the outer surface of the auxiliary sphere (4) and are tapered inward toward the center. Light from the un-encapsulated LED (1) passing through the trapezoid indentations (41) is scattered by the trapezoid indentations (41) to generate a dazzling visual effect.

The trapezoid indentations (31, 41) in the primary and the auxiliary spheres (3, 4) scatter the light from the un-encapsulated LEDs (1) to generates a dazzling visual effect so that the LED light string is attractive. Furthermore, the heat from the un-encapsulated LEDs (21) dissipates through the heat dissipation holes (21) in the transparent casings (2) so that the un-encapsulated LEDs (21) are more durable as compared with encapsulated LEDs and the LED light string has a longer life as compared with conventional LED string with encapsulated LEDs.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the fill extent indicated by the broad general meaning of the terms in which the appended claims are expressed.

What is claimed is:

1. A light emitting diode (LED) light string comprising
multiple wires;
multiple un-encapsulated LEDs, and each encapsulated LED connected electrically to two of the wires;
multiple transparent casings mounted respectively around, respectively receiving and holding the un-encapsulated LEDs (1), and each transparent casing having
a cavity defined in the transparent casings and receiving and holding one of the un-encapsulated LEDs.
two ends; and
two sets of multiple heat dissipation holes, and the heat dissipation holes of each set defined in one end of the transparent casing and communicating with the cavity in the transparent casing, wherein at least two of the wires extend respectively through at least two of the heat dissipation holes of each set;
multiple primary spheres being transparent, mounted around, respectively receiving and holding the un-encapsulated LEDs, and each primary sphere having
a center;
an outer surface;
a cavity defined in the primary sphere and receiving and holding one of the transparent casings;
two end openings defined through the primary sphere, communicating with the cavity in the primary sphere and through which the wires extend; and
multiple trapezoid indentations defined in the outer surface of the primary sphere and tapered inward toward the center; and
multiple auxiliary spheres transparent, mounted around at least two of the wires, arranged alternately with the primary spheres, and each auxiliary sphere having
a center;
an outer surface;
two sets of multiple end openings, and the end openings of each set defined through the auxiliary sphere, wherein at least two of the wires extend respectively through at least two of the end openings of each set of the auxiliary sphere; and
multiple trapezoid indentations defined in the outer surface of the auxiliary sphere and tapered inward toward the center.

2. The LED light string as claimed in claim 1 ffurther comprising multiple heat-shrinkable tubes, and each heat-shrinkable tube mounted tightly two of the wires adjacent one of the un-encapsulated LEDs.

3. The LED light string as claimed in claim 2, wherein the trapezoid indentations in the primary and the auxiliary spheres are reverse-flat-topped-pyramid shaped.

4. The LED light string as claimed in claim 3, wherein each transparent comprising two casing halves and each casing half has
two ends;
an inside edge;
at least one mounting hole defined in the inside edge at one end of the casing half; and
at least one mounting pin formed on the inside edge at the other end of the casing half and mounted respectively in the at least one mounting hole in the other casing half.

5. The LED light string as claimed in claim 4, wherein each auxiliary sphere comprises two semispherical halves and each semispherical half has
two opposite inside surfaces;
a mounting hole defined in one inside surface; and
a mounting pin is formed on the other inside surface and mounted in the mounting hole in the other semispherical half.
